(19) United States
(12) Patent Application Publication
(10) Pub. No.: US 2022/0402414 A1
(43) Pub. Date: Dec. 22, 2022

(54) AIR MIXER FOR A VEHICLE SEAT

(71) Applicant: GENTHERM INCORPORATED, Northville, MI (US)

(72) Inventors: Scott Wolas, Pasadena, CA (US); Ken Turner, Novi, MI (US); Amey Pise, Union City, CA (US)

(21) Appl. No.: 17/776,623

(22) PCT Filed: Dec. 18, 2020
(86) PCT No.: PCT/US2020/065811

§ 371 Date: May 13, 2022

Related U.S. Application Data
(60) Provisional application No. 62/951,303, filed on Dec. 20, 2019.

(51) Int. Cl. B60N 2/56; B60H 1/00

(52) U.S. Cl. CPC B60N 2/5621; B60H 1/00285; B60H 2001/003

(57) ABSTRACT

An air mixer that includes a first air inlet (110), a second air inlet (112), and a door (114). The first air inlet (110) is configured to connect to a source of conditioned air (A1), and the second air inlet (112) is configured to connect to source of ambient air (A2). The door (114) is configured to move relative to the first air inlet (110) and the second air inlet (112) to adjust an amount of air provided into the air mixer from the source of conditioned air and the source of ambient air. The air mixer may be used in a vehicle seat, a vehicle, or both.

### FIELD

These teachings relate generally to an air conditioning system for a ventilated vehicle seat, and more particularly to an air mixer for mixing air from a cabin or ambient air source and a conditioned air source.

### BACKGROUND

Some vehicles include one or a variety of features for improving occupant comfort, For example, some vehicles or vehicle seats include one or more air movers for moving warm, cold, or ambient air towards an occupant.

While some currently available systems are adequate for their intended purpose, it may be desirable to improve the current state of the art. For example, it may be desirable to have a device that is configured or operable to mix air from a cabin or ambient air source and air from a conditioned air source. The air mixture may be directed into a cabin of a vehicle and/or to a vehicle seat, Such a device may be adapted to better control an output temperature of the air directed at the occupant of the vehicle or vehicle seat compared to other known systems.

### SUMMARY

These teachings provide an air mixer that may be used in an air conditioning system. The air conditioning system may be configured to direct or blow air towards an occupant of a vehicle or vehicle seat. The air directed at the occupant may be warmer, colder, or the same as an ambient temperature of the air inside of the vehicle. Based on a temperature difference between the air from a cabin or ambient air source and the air from a conditioned air source, the air mixer according to these teachings is configured or operable to mix, adjust, or tune an amount or ratio of air from the conditioned air source and the cabin or ambient air source to increase, decrease, or maintain an output temperature of the air that is directed at the occupant of the vehicle or vehicle seat.

Advantageously, by utilizing the air mixer according to these teachings, cost, complexity, and packaging space required to house an air conditioning system may be reduced. Moreover, additional downstream heaters and/or coolers to adjust the output temperature of the air directed at the occupant may be eliminated, which may also decrease cost, complexity, and packaging space.

These teachings provide an air mixer that includes a first air inlet, a second air inlet, and a door. The first air inlet is configured to connect to a source of conditioned air, and the second air inlet is configured to connect to source of ambient or cabin air. The door is configured to move relative to the first air inlet and the second air inlet to adjust an amount of air directed at the occupant or into the cabin of the vehicle from the source of conditioned air and the source of ambient air. The air mixer may be used in a vehicle seat, a vehicle, or both.

### BRIEF DESCRIPTION OF THE DRAWINGS

FIG. 1 illustrates a vehicle and a vehicle seat.

FIG. 2 is a perspective view of the vehicle seat that includes two air conditioning systems.

FIG. 3 is a perspective view of the vehicle seat that includes one air conditioning system.

FIG. 4 is a perspective view of an air mover and an air mixer.

FIG. 5 is an exploded, perspective view of FIG. 4.

FIG. 6A is a perspective, cross-sectional view of an air mixer with the door in a first position.

FIG. 6B is a perspective, cross-sectional view of an air mixer with the door in a second position.

FIG. 6C is a perspective, cross-sectional view of an air mixer with the door in a third position.

FIG. 7 is a perspective view of an air mover and an air mixer.

FIG. 8A is a partially exploded view of FIG. 7.

FIG. 8B is an exploded view of portion of FIG. 8A.

FIG. 9A a perspective view of FIG. 7, with the door in a first position, the air mover is illustrated in transparent.

FIG. 9B is a perspective view of FIG. 7, with the door in a second position, the air mover is illustrated in transparent.

FIG. 10 is a rear perspective view of a vehicle seat.

FIG. 11 is a rear view of an air distribution system for use with a vehicle seat.

FIG. 12 is a perspective view of an air mover and an air mixer.

FIG. 13A is a cross-sectional view of FIG. 12, with the door in a first position.

FIG. 13B is a cross-sectional view of FIG. 12, with the door in a second position.

FIG. 13C is a cross-sectional view of FIG. 12, with the door in a third position.

FIG. 14A is a perspective view of an air mover and an air mixer.

FIG. 14B is a perspective view of an air mover and an air mixer.

FIG. 15A is a cross-sectional view of FIGS. 14A and 14B, with the door n a first position.

FIG. 15B is a cross-sectional view FIGS. 14A and 14B, with the door in a second position.

### DETAILED DESCRIPTION

Vehicle as used herein may be any vehicle. For example, the vehicle may be a passenger car or truck, a motor home, train, airplane, boat, and/or off-road vehicle. The cabin may be any portion of the vehicle where one or more occupants or goods may be seated, stored, or transported.

Vehicle seat as used herein may be any seat or device that may be used to support an occupant or goods. The vehicle seat may include one or more cushions or other support devices on which or against which an occupant or goods may be seated, stored, or transported.

The air conditioning system may be any system and/or device configured or operable to direct air towards, at, or into a region of the vehicle, cabin, vehicle seat, operator, or a combination thereof. The directed air may be conditioned air (i.e., warm air or cold air), ambient air, or a mixture or combination of conditioned air and ambient air. Ambient air as used herein may be air located inside of the cabin of the vehicle, air located inside any other portion of the vehicle like a trunk, or air located outside of the vehicle.

The air conditioning system or one or more components thereof may be located anywhere in the vehicle. For example, the air conditioning system or components thereof may be located in, under, or adjacent a vehicle seat; in, under, or adjacent one or more of the cushions; in, under, or adjacent a dashboard, headliner, door panels, footwells, of a vehicle; in the engine bay or trunk, or any combination thereof. For example, one or more of the conditioned air sources may be located in the engine bay or trunk and connected to the air mixer or air mover with one or more tubes or ducts.

Air may be expelled from an air outlet of the air mixer, air mover, air conditioning system. or a combination thereof. The air outlet of the air mixer, air mover, air conditioning system, or a combination thereof may be located in, under, or adjacent to a vehicle seat; in, under, or adjacent one or more of the cushions; in, under, or adjacent a dashboard, headliner, door panels of a vehicle, or any combination thereof. Air expelled from the air outlet may be directed towards, at, or in a region of an occupant's head, neck, shoulders, back, chest, arms, hands, torso, legs, feet, or a combination thereof. The expelled air may be conditioned air, ambient air, or a mixture or both conditioned and ambient air.

The air conditioning system may include one or more thermometers or probes for measuring or obtaining: a temperature of air exiting the source of conditioned air; a temperature of air exiting the source of cabin or ambient air; a temperature of air entering the air mixer from one or both of the sources of air; a temperature of air exiting the air mixer or air mover; a temperature of air passing through the air mixer or air mover; or a combination thereof. Based on one or more temperature measurements from the thermometers or probes, and on a desired or set temperature by an occupant, the air mixer is configured to move one or more doors relative to one or more of the air inlets to adjust a size of the opening of the corresponding air inlets to adjust an amount or ratio of air allowed or available to enter or flow into the air mixer or air mover from the corresponding air source (i.e., conditioned or ambient). By way of this adjustment, a temperature of air exiting the air mixer and/or air mover and flowing out of the air outlet and into the cabin or towards the occupant can be adjusted or fine-tuned, without the need for additional heaters or coolers downstream of the air mover.

Air mixer as used herein may be any device or combination of devices operable or configured to regulate, direct, and/or control the type and/or temperature of air expelled from the air outlet. The air mixer may be configured to regulate, tune, or adjust a ratio of an amount or temperature of air provided to or towards an occupant from or by a conditioned air source and an amount of air provided from or by a cabin or ambient air source. For example, the air mixer may direct or expel air towards the occupant entirely from the conditioned air source; entirely from the cabin or ambient air source; or from both of the conditioned air source and the cabin or ambient air source. The air mixer is configured to regulate, tune, or adjust, the amount of air provided from the sources based on a set temperature desired by the occupant and by the temperature of air exiting the source of conditioned air; exiting the source of cabin or ambient air; entering the air mixer from the two or more sources of air; exiting the air mixer; passing through the air mixer or air mover; or a combination thereof.

The air mixer or air mover comprises a housing. The air mixer or housing has two or more air inlets. Each of the air inlets are connected or fluidly connected to a source of air, which may be one or more conditioned air sources and/or one or more ambient or cabin air sources. The air inlets may be located or arranged at any position relative to each other. For example, the two or more air inlets may be generally parallel to each other. The two or more air inlets may be generally perpendicular to each other. The two or more air inlets may be arranged at an angle that is greater than or less than 90 degrees relative to each other. For example, the angle may be greater than or less than 45 degrees. For example, the angle may be greater than or less than 30 degrees. For example, the angle may be greater than or less than 120 degrees. For example, the angle may be greater than or less than 150 degrees. For example, the angle may be greater than or less than 180 degrees. A cross section or shape of the one or more air inlets may be generally round, oval, square, or any other shape. A cross section or shape of the two or more air inlets may be the same or different. For example, both air inlets may be generally round, oval, square, rectangular, oblong, diamond, or any other shape. For example, one of the air inlets may be generally round, oval, square, rectangular, oblong, diamond, or any other shape, and the other air inlet may have a different shape that is generally round, oval, square, rectangular, oblong, diamond, or any other shape.

The air mixer or air mover may comprise one or more air outlets. The one or more air outlets are configured to expel or direct air into the cabin and/or towards or in a region of an occupant. The one or more air outlets may be arranged at any angle relative to the two or more air inlets. One or more of the air outlets may be arranged along a common axis with one or more air inlets. One or more of the air outlets may be arranged generally perpendicular to one or more air inlets. One or more of the air outlets may be arranged at an angle that is greater than or less than 90 degrees relative to one or more of the air inlets. For example, the angle may be greater than or less than 45 degrees. For example, the angle may be greater than or less than 30 degrees. For example, the angle may be greater than or less than 120 degrees. For example, the angle may be greater than or less than 150 degrees. For example, the angle may be greater than or less than 180 degrees. A cross section or shape of the one or mare air outlets may be generally round, oval, square, or any other shape. A cross section or shape of the one or more air outlets may be the same or different as the shape of the one or more air inlets. For example, the one or more air outlets may be generally round, oval, square, rectangular, oblong, diamond, or any other shape. The one or more air outlets may be arranged along the same axis as the one or more air inlets. The one or more air outlets may be arranged in the same plane as one or more of the air inlets or in a different plane as the one or more air inlets.

The air outlet maybe fluidly connected to an air distribution device. The air distribution device may be a layered component that includes holes or perforations for distributing the air flow from the air outlet. The air distribution device may be a bag structure that is sealed at its periphery. The air distribution system may be provided in or under a vehicle seat. The air outlet maybe fluidly connected to an outlet grill or other air diffuser. For example, the outlet grill or air diffuser may be located anywhere in the vehicle cabin, including the dashboard, door panels, headliner, seat cushion, bolsters, or a combination thereof.

The air mixer comprises one or more doors. The one or more doors may be configured to block, obstruct, or reduce a size of one or more of the air inlets, Each door may be configured to block or obstruct one or more air inlets. For example, the air mixer may have a dedicated door to block or obstruct one or more air inlets. Alternatively, the air mixer may have one door that is configured to block or obstruct two or more air inlets.

The door may include one or more blocking portions for blocking the corresponding one or more air inlets. The one or more blocking portions, also referred to herein as first and second air inlet blocking portions, may be arranged at any angle relative to each other. For example, the blocking portions may be arranged generally parallel to each other, generally perpendicular to each other, or at any angle greater than or less than 90 degrees relative to each other.

The door may be moved to block or obstruct one or more of the air inlets. By blocking, obstructing, or reducing a size of one or more air inlets with the door, an amount of air provided from the respective air source is reduced, minimized, or completely eliminated. The door may be slid along or about an axis to block or obstruct the one or more air inlets. The door may be rotated about an axis to block or obstruct the one or more air inlets. The door may be both slid and rotated about an axis to block or obstruct the one or more air inlets. The door may be slid along or about an axis to unblock or increase a size of the one or more air inlets. The door may be rotated about an axis to unblock or increase a size of the one or more air inlets. The door may be both slid and rotated about an axis to unblock or increase a size of the one or more air inlets. By unblocking or increasing a size of one or more air inlets, an amount of air provided from the respective air source is increased.

The door may be moved along a generally linear or straight path. The door may be moved along a generally curved or circular path. The door may be rotated about an axis between various positions. The axis about which the door rotates may be generally perpendicular to a flow path of the air or aligned with a flow path of the air.

The door may be movable via one or more actuators, motors, or other applicable devices. The door may be movable by an electric control. The door may be movable when a user sets a desired temperature inside the cabin of the vehicle. In response to the set temperature, the door may be moved into a corresponding position to at least partially open or close one or more corresponding openings or passageways. The door may be moved by a manual control. For example, a user or operator may manually turn a knob or slide a slider to adjust an air temperature, which may correspondingly move the door into a corresponding position.

The door may have a generally flat or planar profile. The door may have a curved or rounded profile. The door may be a scoop. The door may have an arc measure of about 90 degrees. The door may have an arc measure of less than 90 degrees. The door may have an arc measure of greater than 90 degrees. The arc measure may be less than 45 degrees or more than 45 degrees. The arc measure may be less than 30 degrees or more than 30 degrees. The arc measure may be less than 120 degrees or more than 120 degrees. The arc measure may be less than 150 degrees or more than 150 degrees. The arc measure may be less than 170 degrees or more than 170 degrees. The door may have a barrel shape. A barrel shaped door is advantageous because a smaller, or lower torque actuator can be used since the door does not have to resist the force of air flow that a flat or planar type of door may see. The door may have a planar wall, a concave scooped wall, a convex scoop wall, or a combination thereof. The door may be substantially rigid. The door may be substantially complaint or flexible to aid in sealing in one or more of the door positions. The door may be a flap of substantially flexible material. The door may be a flexible member that bends or deforms during movement and/or sealing. The door may be a rigid member that does not bend or deform during movement and/or sealing.

The door or the housing of the air mixer may have one or more seals or other features configured to create a fluid seal between the door and one or more walls of the housing to prevent air from leaking between or around the door and the housing. Advantageously, this functions to prevent air from unintentionally mixing with the flow of the air so that a more precise temperature of air exiting the air destitution system can be achieved. The one or more seals may be located at any surface or edge of the door. The one or more seals may be a foam, rubber, EPDM, TPU, TPE, etc. The one or more seals may include a lubricant to allow the door to freely move or slide or rotate between the one or more positions described herein. The door or the one or more seals may contact a wall or housing defining the device, and/or the one or more openings to restrict or prevent air from flowing therethrough.

The conditioned air source may be a source that provides conditioned air. The conditioned air may have a temperature and/or humidity that is less than or greater than a temperature and/or humidity of the air from the cabin or ambient air source. The conditioned air source may be a heater. The conditioned air source may include one or more heaters or thermoelectric devices (TED) to the heat air. The conditioned air source may be a cooler or chiller. The conditioned air source may include one or more chillers, coolers, or thermoelectric devices (TED) to cool the air. The conditioned air source may be a heat exchanger. In some configurations, the conditioned air source may also be configured to supply temperature that is generally the same temperature and/or humidity as the cabin or ambient air source. For example, by turning off the one or more heaters and/or coolers, the conditioned air source may supply air at a temperature and/or humidity that is generally the same as the cabin or ambient air source.

The conditioned air source may provide conditioned air to the air mixer or air distribution system that is generally the same or a constant temperature. This means that the conditioned air source is configured to provide or supply air temperature at the same temperature, regardless of an output temperature requested by an occupant. Stated another way, a temperature of the conditioned air is not modulated or changed, and/or a temperature of the conditioned air is not modulated or changed based on response to a desired output temperature of the air distribution system. For example, the conditioned air source may supply conditioned air at a temperature of about 60 degrees Fahrenheit, however, temperatures higher or lower than this may be used.

The cabin or ambient air source may be a source that provides cabin or ambient air. The cabin or ambient air may have a temperature and/or humidity that is less than or greater than a temperature and/or humidity of the air from the conditioned air source. The cabin or ambient air source may be the cabin of the vehicle. The cabin or ambient air source may be air from the surroundings of the vehicle. The cabin or ambient air source may be located under or behind a vehicle seat.

The system may include one or more actuators. The actuator may comprise a motor, a computer or controller, one or more links, or a combination thereof. The actuator may be located inside of the air mixer housing. The actuator may be located outside of the air mixer housing. The one or more actuators may comprise a stepper motor or a servo motor. The actuator may cause or be operable to cause the door to move between one or more of the door positions disclosed herein. The actuator may rotate, move, slide, displace, reposition, or otherwise move the door between the positions. The actuator may include one or more links, pivots, bends, joints, bearings, or other members to assist with moving the door between the one or more positions.

The computer, whether part of the actuator, or electrically connected to the actuator, is configured to determine a position of the door relative to the one or more air inlets. The computer may comprise a memory, a processor, a circuit board, or a combination thereof. Based on one or more temperature measurements from one or more thermometers or probes in the vehicle, cabin, and/or air distribution system, and a desired or preset temperature by an occupant, the air mixer is configured to move one or more doors relative to one or more of the air inlets defined in the air mover or air mixer to adjust a size of the opening of the corresponding air inlets to adjust an amount or ratio of air entering the air mixer or air mover from the corresponding air source (i.e., conditioned or ambient). By way of this adjustment, a temperature of air exiting the air mixer and/or air mover and flowing out of the air outlet and into the cabin or towards the occupant can be adjusted or fine-tuned, without the need for additional heaters or coolers downstream of the air mover.

The computer may comprise a circuit board or the circuit board may comprise a computer. The computer or circuit board may receive one or more communication signals from a vehicle control unit or other computer to turn the air mover and/or mixer ON and OFF, adjust a speed of the air mover, and/or adjust a position of the door. The computer or circuit board may receive one or more power signals from a vehicle control unit or other computer to turn the air mover and/or mixer ON and OFF, adjust a speed of the air mover, adjust a position of the door, or a combination thereof. The computer or circuit board may include a plug with one or more prongs, pins, or other conductors to connect to the vehicle controller. The computer or circuit board may be located within the same housing as the air mover, the air mixer, or both. The computer or circuit board may be located in a housing that is integrally formed with the housing of the air mover and/or air mixer or attached thereto via one or more fasteners. The computer and/or circuit board may function to send signals to the vehicle controller or vehicle computer regarding an operating speed and/or temperature of air entering and/or leaving the air mixer and/or air mover. The computer and/or circuit board may function to send signals to the vehicle controller or vehicle computer regarding a position of the door relative to the first and/or second air inlet. An operator of the vehicle or seat may send one or more signals to the air mover and/or air mixer via the one or more plugs, circuit boards, computers, or a combination thereof to adjust the air flow temperature and/or speed exiting the air mover and/or the air mixer.

The air conditioning system may include one or more air movers. An air mover may be any device or combination of device configured or operable to move air. The air mover may increase a flow, speed, or velocity of the air. The air mover may decrease a flow, speed, or velocity of the air. The air mover may be a fan. The air mover may be a radial fan. The air mover may be an axial fan. The air mover may direct air from one or more or two or more sources of air into the air mixer. The air mover may be located downstream of the air mixer and may pull or suction air into the air mixer. The air mover may be located upstream of the air mixer and may push air into the air mixer. The air mover may switch between pulling and pushing air into the air mixer from the two or more sources of air. The air conditioning system may include a dedicated air mover for each source of air.

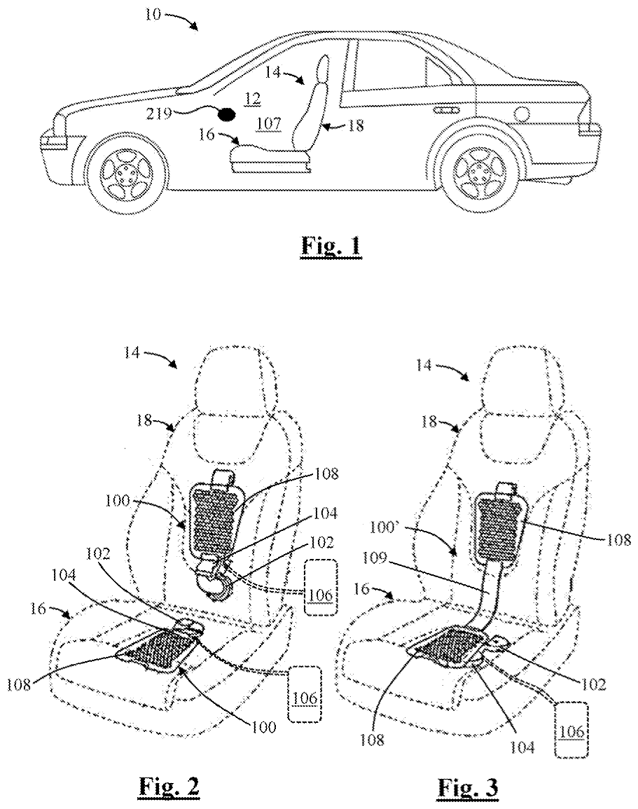

A vehicle 10 is shown in FIG. 1. The vehicle 10 comprises a cabin 12 that includes one or more vehicle seats 14. The vehicle seat 14 comprises a seating portion 16 and a backrest portion 18. One or more NTC or other temperature sensors or probes 219 may be provided in the cabin 12. The temperature sensors or probes 219 may function to measure a temperature or air temperature inside the cabin 12. The inside of the cabin may also be referred to herein as an ambient air source 107

FIG. 2 illustrates a vehicle seat 14. The seat 14 includes one or more air conditioning systems 100 in the seating portion 16 and one or more air conditioning systems 100 in the backrest portion 18. Each air conditioning system 100 may comprise one or more air movers 102 one or more air mixers 104, and one or more air distributors 108.

A conditioned air source 106 may be a component of the air conditioning system 100 and separate from a vehicle conditioning source. Alternatively, the conditioned air source 106 may be part of the vehicle 10 for supplying warm and/or cold air to other parts of the vehicle 10, such as to the windshield, dashboard, floor vents, rear window or rear cabin area, or a combination thereof. The conditioned air source 106 may be connected to the air conditioning system 100 for supplying warm and/or cold air to the air conditioning system 100.

Another vehicle seat 14 is illustrated at FIG. 3, In the FIG. 3, one or more air conditioning systems 100′ is provided for both of the seating and backrest portions 16, 18. The air conditioning system 100′ comprises one or more air movers 102, one or more air mixers 104, one or more air distributors 108 (two illustrated), and one or more ducts 109 between the distributors 108. One of the air distributors 108 is provided in the seating portion 16 and the other air distributor 108 is provided in the backrest portion 18, However, it is within the scope that two or more distributors 108 may be provided in the seating portion 16 and/or in the backrest portion 18. The two air distributors 108 are fluidly connected together with the one or more ducts 109 so that air can flow between the two or more air distributors 108. While the air mover 102 and air mixer 104 are illustrated as located in the seating portion 16, it is understood the air mover 102 and air mixer 104 can instead be located in the backrest portion 18. Alternatively, the air mover and/or mixer can be located anywhere else in the vehicle and the air can be transported

The conditioned air source 106 may function to supply warm and/or cold air. The conditioned air source 106 may be a component of the air conditioning system 100′ that is separate from a vehicle conditioning system. Alternatively, the conditioned air source 106 may be part of the vehicle 10 for supplying warm and/or cold air to other parts of the vehicle 10 as was discussed above and may be connected to the air conditioning system 100′.

Any disclosures herein relating to the air mover, the air mixer, the air distribution system, the air sources, and a combination thereof, apply to all examples. This means that all teachings and/or disclosures in the figures and/or paragraphs may be imported, combined, duplicated, and/or substituted with any other features or elements in any of the other figures and paragraphs, and vice versa

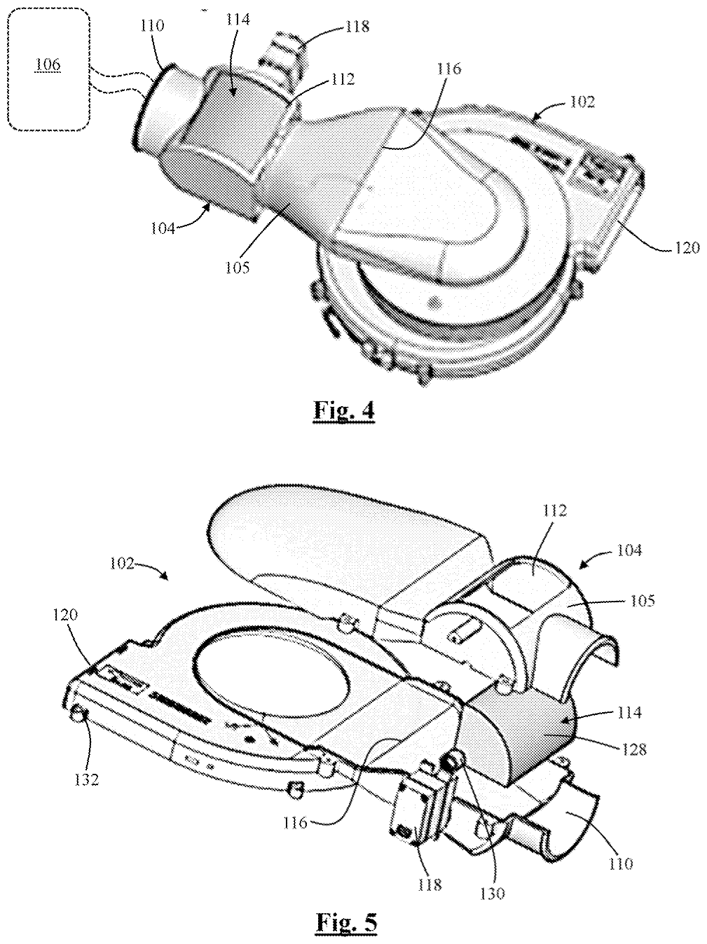

Referring to FIGS. 4 and 5. the air mixer 104 comprises a housing 105 that has a first air inlet 110, a second air inlet 112, a door 114, and an air outlet 116. The first air inlet 110 is connected to or in fluid communication with the conditioned air source 106, which may be a source of warm air, a source of cold air, or both. The second air inlet 112 is located downstream of the first air inlet 110 and is connected to, in fluid communication with, or opens to a cabin or ambient air source 107 located inside the cabin 12 of the vehicle 10 (See FIG. 1). The cabin 12 or ambient air source 107 contains air inside of the vehicle 10 or cabin 12, which may also be referred to as ambient air. An actuator 118 is connected to the door 114. The actuator 118 is configured or operable to move the door 114 between a plurality of positions discussed further below relative to the first and second air inlets 110, 112. The housing 105 may include one or a plurality of mounting features 132 for attaching the air mixer 104 and/or air mover 102 to the vehicle 10, the seat 14, the cushions 14, 16, suspension, frame, or any other structure.

The air mover 102 is connected to the air outlet 116 of the air mixer 104. However, in some configurations, the air mover 102 and the air mixer 104 may be formed as a single, integral member. For example, the features of the air mixer 104 may be incorporated into the housing of the air mover 102, or vice versa. For example, the features of the air mixer 104 may be connected to the features of the air mover 102, or vice versa so there is one structural component of the units 102, 104. This may be desired for assembly and/or handling purposes. However, in other configurations, it may be desirable for the two components 102, 104 to be formed as separate elements and then joined together before or during assembly of the system. This may be desirable for packaging purposes, if different air movers and/or mixers are utilized for different applications, and the like.

The air mover 102 is configured to move, pull, or draw air into the housing 105 of the air mixer 104 through either or both of the first and second air inlets 110, 112, depending on the position of the door 114 relative to the air inlets 110, 112. However, in certain configurations, the air mover 102 and the air mixer 104 may be reconstructed so that the air mover 102 functions to push air into and through the housing 105 of the air mixer 104 This may be in addition or instead of an air mover 102 pulling or drawing air into the air mixer 104.

The air mover 102 comprises an outlet 120 through which the air exits the air mover 102. The outlet 120 may be directed into the vehicle cabin 12. The outlet 120 may be directed towards an occupant of the vehicle cabin 12 and/or the vehicle seat 14 (FIG. 1). The outlet 120 may be connected to one or more air distributors 108 for blowing, distributing, and/or diffusing air into the cabin 12 and/or towards an occupant in the seat 14.

The door 114 comprises a wall 128 or scoop or barrel connected to an arm 130. The wall 128 may be curved. The curved wall 128 has an arc measure of approximately 90 degrees, defined between two planar edges or surfaces. However, the arc measure of the curved wall 128 may be less than 90 degrees or greater than 90 degrees. In certain other configurations, the wall 128 may be generally planar or straight. In certain configurations, the wall 128 may be convex shaped. The geometry of the wall 128 may correspond or complement the wall of the housing where the two openings 112, 110 are arranged. That is, the wall 128 may have any suitable geometry for sealing or closing off one or both of the openings 110, 112 depending on the position of the door 114.

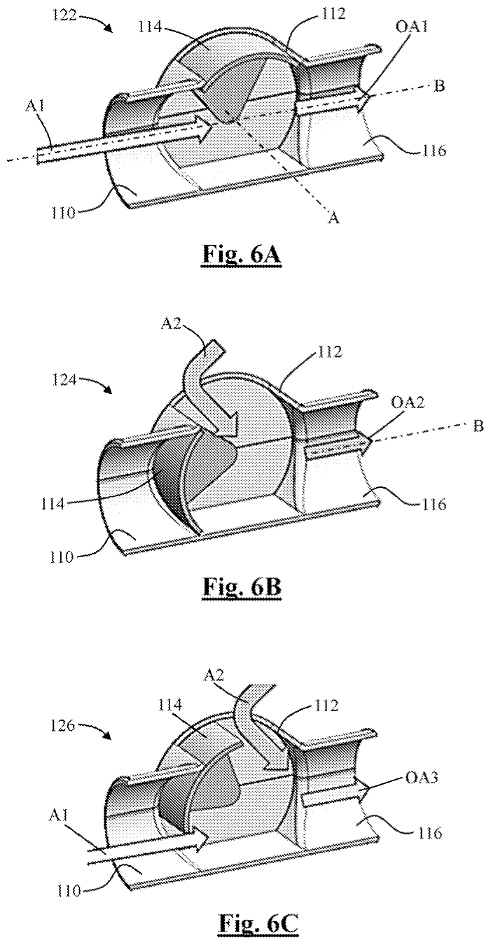

The arm 130 is connected to one or more actuators 118. Thea arm 130 may be connected directly to the actuator 118, The arm may be connected to the actuator 118 via one or more intermediate members, such as links, cams, and/or pivots. The actuator 118 is configured or operable to move the door 114 into or between the door positions 122, 124, 126 illustrated in FIGS. 6A-6C.

FIGS. 6A, 6B, and 6C, illustrate the door 114 in various door positions 122, 124, and 126, respectively. The door 114 is moved into the various positions 122, 124, 126 by moving or rotating the door 114 with the actuator 118. The door 114 may be rotated about an axis A into the positions 122, 124, 126. The axis A may be generally perpendicular to an axis or flow path B that the air entering and/or exiting the air mixer 104 at the air inlet 110 and/or outlet 116 and/or the path of the air flowing through the air mixer 104, between the first air inlet 110 and the air outlet 116.

FIG. 6A illustrates the door 114 of the air mixer in the first position 122 In the first position 122, the door 114 blocks or obstructs the second air inlet 112. In the first position 122, the door 114 does not block or obstruct the first air inlet 110. Accordingly, by way of the air mover 102 being connected to the air outlet 116 of the air mixer (See FIGS. 4, 5), when the door 114 is in the first position 122, only conditioned air A1 from the conditioned air source 106 (FIGS. 2-4) is drawn or pulled into the air mixer 104 via the first air inlet 110. The ambient air A2 from the ambient air source 107 (i.e., cabin air; FIG. 1) is blocked, obstructed, or prevented from being pulled or drawn into the air mixer 104 because the door 114 blocks or obstructs the second air inlet 112. The conditioned air A1 flows through the air mixer 114 and then exits the air mixer 114 via the air outlet 116 as conditioned output air OA1. The conditioned output air OA1 is then pulled or drawn through the air mover 102 (FIGS. 4, 5) before being directed towards the occupant or into the air distributor 108 (FIGS. 2, 3) for distribution into the cabin and/or towards the occupant or inside the vehicle 10.

FIG. 6B illustrates the air mixer 104 with the door 114 in the second position 124. In the second position 124, the door 114 blocks or obstructs the first air inlet 110. In the second position 124, the door 114 does not block or obstruct the second air inlet 112. Accordingly, by way of the air mover 102 being connected to the air outlet 116 (See FIGS. 4, 5), when the door 114 is in the second position 124, only ambient air A2 from the cabin or ambient air source 107 (FIG. 1) is drawn or pulled into the air mixer 104 via the second air inlet 112. The conditioned air A1 is not pulled or drawn into the air mixer 104 because the door 114 blocks or obstructs the first air inlet 110. The ambient air A2 flows through the air mixer 114 and then exits the air mixer 114 via the air outlet 116 as ambient output air OA2. The ambient output air OA2 flows is then pulled or drawn through the air mover 102 (FIGS. 4, 5) before being directed towards the occupant or into the air distributor 108 (FIGS. 2, 3) for distribution towards the occupant or inside the vehicle 10.

FIG. 6C illustrates the air mixer 104 with the door 114 in the third position 126. In the third position 126, the door 114 only partially blocks or obstructs the first air inlet 110 and only partially blocks or obstructs the second air inlet 112. In other words, in the third position 126, the door 114 is between the first and second door positions 122, 124 so that the door 114 does not completely block or obstruct the first air inlet 110 and does not completely block or obstruct the second air inlet 112, Instead, both inlets 110, 112 are partially open or unobstructed. Accordingly, by way of the air mover 102 being connected to the air outlet 116 (See FIGS. 4, 5), when the door 114 is in the third position 126, conditioned air A1 from the conditioned air source 106 is drawn into the air mixer 104 through the first air inlet 110 and ambient air A2 from the cabin or ambient air source 107 is drawn into the air mixer 104 through the second air inlet 112. A combined conditioned air and ambient output air OA3 exits the air mixer 114 via the air outlet 116. The combined conditioned air and ambient output air OA3 is then pulled or drawn through the air mover 102 (FIGS. 4, 5) before being directed towards the occupant or into the air distributor 108 (FIGS. 2, 3) for distribution towards the occupant or inside the vehicle 10.

The amount or ratio of the conditioned air A1 to the ambient air A2 that is expelled from the air output 116 dictates an output temperature of the air that is expelled from the air mixer 104 and/or air conditioning system 100. By measuring a temperature of the conditioned air A1 and a temperature of the ambient air A2 and corresponding a desired air temperature set by the occupant to the measured temperatures of the conditioned A1 and ambient air A2, the door 114 is moved into one of the positions 122, 124, 126, or into a position therebetween.

For example, when more conditioned air A1 is desired or required (i.e., when a warmer or colder air output temperature relative to the ambient air is desired), the door 114 is moved so that the first inlet 110 is less blocked or obstructed and the second inlet 112 is more blocked or obstructed. This allows a greater amount of conditioned air A1 to flow into/through the air mixer 104 and expelled from the air distribution system 100.

Conversely, when less conditioned air A1 is desired or required (i.e., an air output temperature closer to ambient is desired), the door 114 is moved so that the first inlet 110 is more blocked or obstructed and the second inlet 112 is less blocked or obstructed. This allows a greater amount of the ambient air A2 to flow into/through the air mixer 104 and be expelled from the air distribution system 100. The foregoing example applies to all of the air mixer and system embodiments disclosed herein.

With continued reference to FIG. 6C, an exemplary operation of the air mixer 104 will be discussed. The conditioned air A1 supplied to the air mixer 104 may have a temperature on the order of about 60 degrees Fahrenheit. The ambient air A2 supplied to the air mixer 104 may have a temperature on the order of about 90 degrees. If an occupant requested air output temperature OA3 from the air mixer 104 is the order of about 70 degrees Fahrenheit, a controller and/or the actuator may drive, move, or rotate the door 114 to a position between the first and second inlets 110, 112 such that a sufficient amount of the conditioned air A1 enters the air mixer 104 and a sufficient amount of ambient air A2 enters the air mixer 104. After being mixed together in the air mixer 104, the air exits the air mixer 104 at output 116 as a combined conditioned air and ambient output air OA3 having a temperature of approximately 70 degrees. Accordingly, other systems that do not include such an air mixer 104 or air distribution system 100 according to these teachings may require an additional heating device downstream of the conditioned air source to heat the conditioned A1 from 60 degrees to 70 degrees. Additionally, or alternatively, other systems that do not include such an air mixer 104 or air distribution system 100 according to these teachings may require an additional cooling device to cool the ambient air A2 from the exemplary 90-degree temperature down to the requested 70-degree temperature.

The corresponding of the desired output temperature set by the occupant to the measured temperatures of the conditioned air A1 and the ambient air A2 to adjust or set a position 122, 124, 126 of the door 114 relative to the inlets 110, 112 may be calculated or performed by a computer or processor executing one or more algorithms or equations. Alternatively, or additionally, a lookup-table may be utilized to correspond a desired output temperature set by the occupant to the measured temperatures of the conditioned air A1 and the ambient air A2 to adjust or set a position 122, 124, 126 of the door 114 relative to the inlets 110, 112.

To measure or understand the temperature of the conditioned air A1 in or exiting the conditioned air source 106 and the temperature of the ambient air A2 in the cabin or ambient air source 107, the air distribution system 100 includes one or more NTC or other temperature sensors or probes provided in or adjacent to the respective sources 106, 107. The NTC or other temperature sensors or probes are configured to provide temperature information to a controller or processor, which then corresponds or calculates or uses a look up table to determine the optimal position of the door 114 relative to the inlets 110 112. The door 114 is then moved into the proper position with the actuator 118.

The foregoing remarks apply to all examples disclosed herein and vice versa.

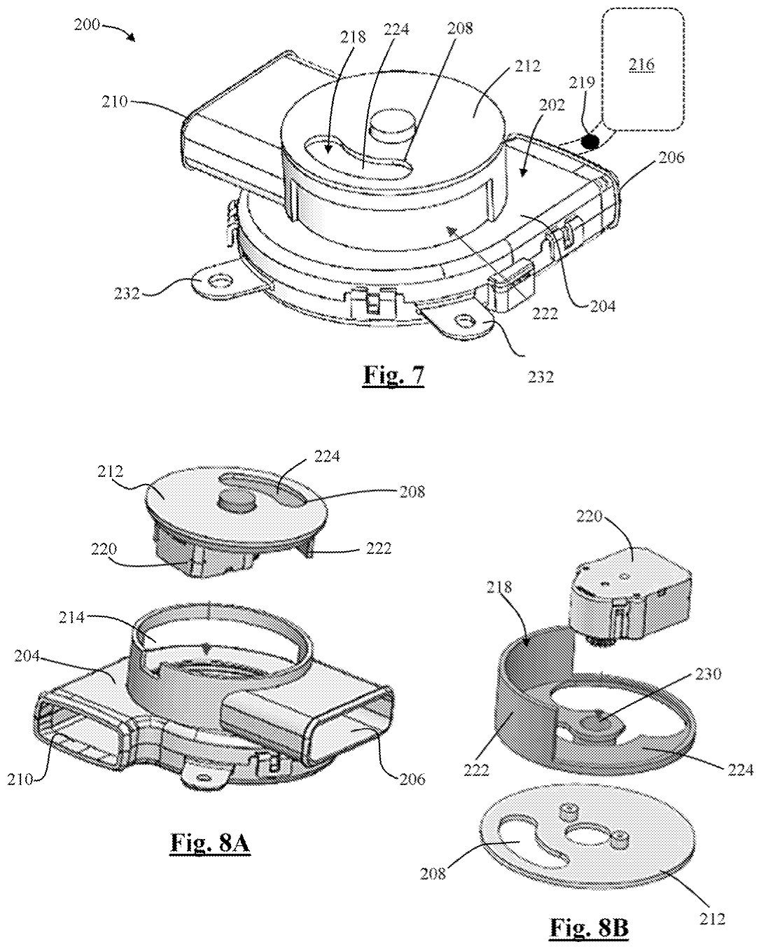

FIGS. 7, 8A, and 8B illustrate an air mixer 200 and air mover 202. The air mixer 200 and air mover 202 may be used in the system 100, 100′, in place of the air mixer 104 and air mover 102. Thus, the disclosure of the air mixer 200 and air mover 202 may apply to the disclosure of the air mixer 104 and air mover 102, and vice versa

The air mover 202 comprises a housing 204 that has a first air inlet 206, a second air inlet 208 downstream from the first air inlet 206, and an air outlet 210. The second air inlet 208 may be defined in a cap or cover 212 that is configured to be received into a flange or chimney 214 defined in the housing 204. The cover 212 may be a separate piece from the housing 204 to aid in assembly and/or manufacturing of the air mixer, however, it is understood these components may be formed from a single, integral structure. The housing 204 may include one or a plurality of mounting features 232 for attaching the air mixer 200 to the vehicle 10. the seat 14, the cushions 14, 16, or any other structure.

The first air inlet 206 is connected to or in fluid communication with a conditioned air source 216. The conditioned air source 216 may part of the air conditioning system 100, 100′ for supplying warm and/or cold air to the air conditioning system 100. Alternatively, the conditioned air source 216 may be part of the vehicle 10 for supplying warm and/or cold air to other parts of the vehicle 10 and may be connected to the air conditioning system 100, 100′ for supplying warm and/or cold air to the air conditioning system 100, 100′.

The second air inlet 208, which is located downstream of the first air inlet 206, is connected to or open to ambient air inside of the vehicle cabin 12, referred to as a cabin or ambient air source 107 (FIG. 1).

The air mixer 200 comprises a door 218. The door 218 is configured or operable to be moved into a plurality of positions relative to the air inlets 206, 208. An actuator 220 is connected to the door 218, and configured or operable to move the door 218 between the plurality of positions. The air mover 202 is configured to move, pull, or draw air into the air mixer 200 through either or both of the air inlets 206, 208, depending on the position of the door 218 relative to the air inlets 206, 208.

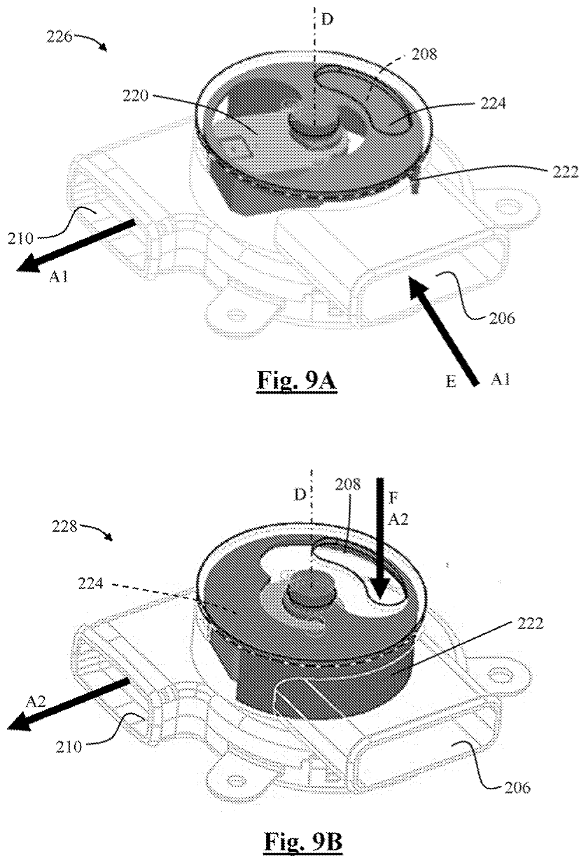

The door 218 comprises a curved wall or scoop defining a first air inlet blocking portion 222 and a second air inlet blocking portion 224. The blocking portions are 222, 224 are arranged on planes that are generally perpendicular to one another. The door 218 comprises a receiver 230 configured to engage an output of the actuator 220. By way of the engagement between the actuator 220 and the receiver 230, the actuator 220 is configured or operable to move or rotate the door 218 between or into the various positions 226, 228 illustrated in FIGS. 9a-9b.

FIGS. 9A and 9B illustrate the door 218 in the various positions 226, 228. The door 218 is moved into the various positions 226, 228 by rotating the door 218 with the actuator 220 about an axis D. The axis D may be generally perpendicular to an axis or flow path E that the air enters the air mixer 200 through the first air inlet 206 (FIG. 9a). The axis D may be generally aligned with or parallel to an axis or flow path F that the air enters the air mixer 200 through the second air inlet 208 (FIG. 9b)

FIG. 9A illustrates the air mixer 200 with the door 218 in the first position 226. In the first position 226, the second air inlet blocking portion 224 blocks or obstructs the second air inlet 208. In the first position 226, the first air inlet blocking portion 222 of the door 218 does not block or obstruct the first air inlet 206. Accordingly, by way of the air mover 102, when the door 218 is in the first position 226, only the conditioned air A1 from the conditioned air source 216 (FIG. 7) is drawn or pulled into the air mixer 200 via the first air inlet 206. The ambient air A2 from the ambient air source 107 (FIG. 1) is not pulled or drawn into the air mixer 200 because the second air inlet blocking portion 224 blocks or obstructs the second air inlet 208. The conditioned air A1 flows through the air mixer 200 and then exits the air mixer 200 via the air outlet 210. The conditioned air A1 is then directed towards the occupant or into the air distributor 108 (FIGS. 2, 3) for distribution towards the occupant or inside the vehicle 10.

FIG. 9B illustrates the air mixer 200 with the door 218 in the second position 228. In the second position 228, the first air inlet blocking portion 222 of the door 218 blocks or obstructs the first air inlet 206. In the second position 228, the second air inlet blocking portion 224 of the door 218 does not block or obstruct the second air inlet 208. Accordingly, by way of the air mover 102, when the door 218 is in the second position 228. only the ambient air A2 from the ambient air source 107 (FIG. 1) is drawn or pulled into the air mixer 200 via the second air inlet 208. The conditioned air A1 from the conditioned air source 216 (FIG. 7) is not pulled or drawn into the air mixer 200 because the first air inlet blocking portion 222 blocks or obstructs the first air inlet 206. The ambient air A2 flows through the air mixer 200 and then exits the air mixer 200 via the air outlet 210. The ambient air A2 is then directed towards the occupant or into the air distributor 108 (FIGS. 2, 3) for distribution towards the occupant or inside the vehicle 10.

While not illustrated, the door 218 can be moved into a third position. In the third position, similar to the third position 126 illustrated above at FIG. 6c, the door 218 only partially blocks or obstructs the first air inlet 206 and only partially blocks or obstructs the second air inlet 208. In other words, in the third position, the door 218 does not completely block or obstruct the first air inlet 206 and does not completely block or obstruct the second air inlet 208. Accordingly, when the door 114 is in the third position, the conditioned air A1 from the conditioned air source 216 is drawn into the air mixer 200 through the first air inlet 206, and the ambient air A2 from the cabin or ambient air source 107 is drawn into the air mixer 200 through the second air inlet 208. A combined conditioned air and ambient air exits the air mixer 200 via the air outlet 210. The combined conditioned air and ambient air is then directed towards the occupant or into the air distributor 108 (FIGS. 2, 3) for distribution towards the occupant or inside the vehicle 10.

The amount or ratio of the conditioned air A1 to the ambient air A2 that is expelled through the air output 210 dictates an output temperature of the air that is expelled from the air conditioning system 100 and directed towards the occupant. By measuring a temperature of the conditioned air A1 and a temperature of the ambient air A2 and corresponding a desired air temperature set by the occupant to the measured temperatures of the conditioned A1 and ambient air A2, the door 218 is moved into one of the positions 226, 228, or into a position therebetween.

For example, when more conditioned air A1 is desired or required (i.e., when a warmer or colder air output temperature relative to the ambient air is desired), the door 218 is moved so that the first inlet 206 is less blocked or obstructed and the second inlet 208 is more blocked or obstructed. This allows a greater amount of conditioned air A1 to flow into/through the air mixer 200 and expelled from the air distribution system 100.

Conversely, when less conditioned air A1 is desired or required (i.e., an air output temperature closer to ambient is desired), the door 218 is moved so that the first inlet 206 is more blocked or obstructed and the second inlet 208 is less blocked or obstructed. This allows a greater amount of the ambient air A2 to flow into/through the air mixer 200 and be expelled from the air distribution system 100.

The corresponding of the desired output temperature set by the occupant to the measured temperatures of the conditioned air A1 and the ambient air A2 to adjust or set a position 226, 228 of the door 218 relative to the inlets 206, 208 may be calculated or performed by a computer or processor executing stored algorithms or equations. Alternatively, or additionally, a lookup-table may be utilized to correspond the desired output temperature set by the occupant to the measured temperatures of the conditioned air A1 and the ambient air A2 to adjust or set a position 206, 208 of the door 218 relative to the inlets 206, 208.

To measure or understand the temperature of the conditioned air A1 in or exiting the conditioned air source 216 and the temperature of the ambient air A2 in the cabin or ambient air source 107, the air distribution system 100 includes one or more NTC or other temperature sensors or probes 219 provided in or adjacent to the respective sources 216, 107 and/or within the air flow exiting the respective sources 206, 107 (See FIG. 7 and FIG. 1, respectively). The NTC or other temperature sensors or probes 219 are configured to provide temperature information to a controller or processor, which then corresponds or calculates the required position of the door 218 relative to the inlets 206, 208. The door 218 is then moved into the proper position with the actuator 220.

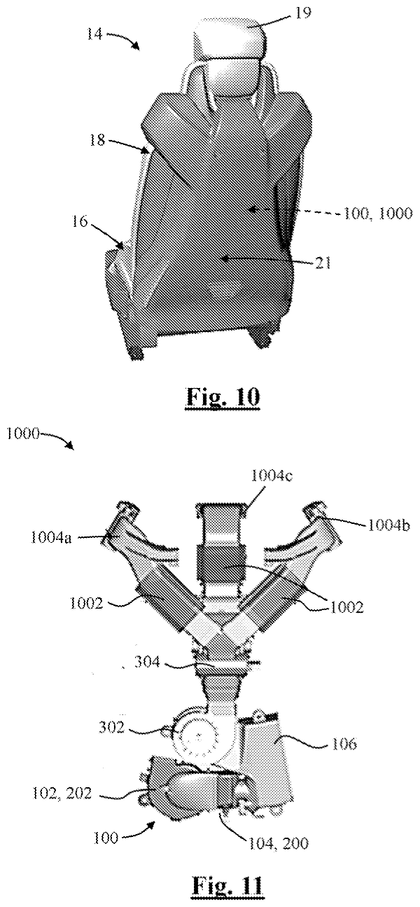

FIG. 10 illustrates a back side of the vehicle seat 14. In addition to the seating portion 16 and the backrest portion 18, the vehicle seat 14 comprises a headrest 19. The air distribution system 100 may be provided or attached to a backside of the backrest portion 18, and within a back cover 21. One or more components of the air distribution system 100 may be included in an air distribution system 1000 provided or attached to the backside of the backrest portion 18, and within the back cover 21. Air distribution system 1000 is further illustrated and described at FIG. 11.

Referring now to FIG. 11, the air distribution system 1000 may comprise one or more of the elements or features of the air distribution system 100 described herein. The air distribution system 100 of system 1000 may comprise: the source of conditioned air 106, the air mixer 104, 200 located upstream of the source of conditioned air 106, the air mover 102, 202 connected to the air mixer 104. 200 The air outlet corresponding to the air mixer or air mover may be connected to one or more ducts or passageways 1002. The one or more ducts or passageways 1002 may be connected to one or more air outlets 1004 a,b,c. A temperature of the air exiting the outlet 116, 210 may be generally the same as a temperature of the air flow exiting one or more of the outlets 1004 a, b, c. Outlets 1004a, 1004b may be located or positioned generally at the shoulder regions of an occupant in the vehicle seat 14 and outlet 1004c may be positioned generally at the next region of an occupant in the vehicle seat 14.

The system 1000 may also include system 300, which may include the same or another air mover 302, an air distribution device 304, and ducts 1002 leading to respective outlets 1004a, 1004b, 1004c. The air distribution device 304 may be a valve or a 3-way valve, which may be used to distribute or direct air flow into one or more of the outputs 1004a, 1004b, 1004c. For example, in one configuration, the system 300 may be configured or operable to distribute an airflow to only outputs 1004a and 1004b; in another configuration, the system 300 may be configured or operable to distribute an airflow to only output 1004c, and in yet another configuration, the system may be operable to distribute an airflow to all outputs 1004a, 1004b, 1000c. The outputs 1004a, 1004b, 1000c may also be referred to as effectors, or seat effectors. The system 300 is further disclosed in Applicant's co-pending application, which is expressly incorporated by reference herein for all purposes.

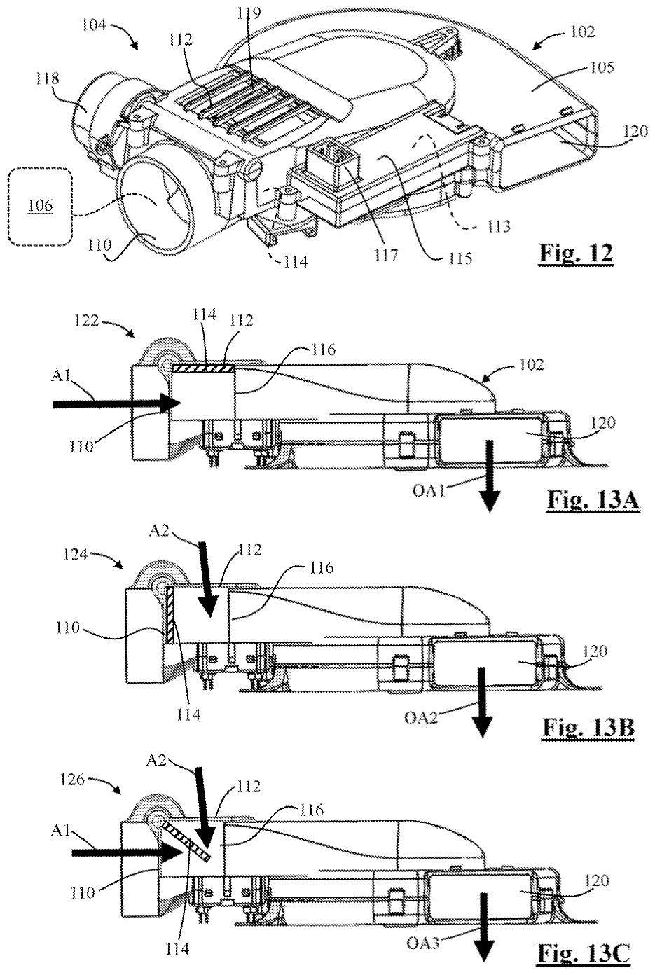

Referring to FIG. 12, an air mixer 104 comprises a housing 105 that has a first air inlet 110, a second air inlet 112, a door 114 (FIGS. 13A-C), and an air outlet 116. A grill 119 may be provided over the second air inlet 112. The grill 119 may include one or more ribs, projections, slate, or other horizontal, diagonal, or vertical members that reduce the size of the inlet 112. The grill 119 may be a netting, screen, and/or webbing. The grill 119 may function to restrict or prevent foreign objects, dust, debris, or other contaminants from entering the air mixer 104, air mover 102, or both. The grill 119 may be placed over or in front of the first opening 110. The grill 119 may be placed downstream of one or both of the inlets 110, 112. The grill 119 may be added to any of the other embodiments disclosed herein.

The first air inlet 110 is connected to or in fluid communication with the conditioned air source 106, which may be a source of warm air, a source of cold air, or both. The second air inlet 112 is located downstream of the first air inlet, 110 and is connected to, in fluid communication with, or opens to a cabin or ambient air source 107 located inside the cabin 12 of the vehicle 10 (See FIG. 1). The cabin 12 or ambient air source 107 contains air inside of the vehicle 10 or cabin 12. which may also be referred to as ambient air. An actuator 118 is connected to the door 114. The actuator 118 is configured or operable to move the door 114 between a plurality of positions discussed further below in FIGS. 13A-C, relative to the first and second air inlets 110, 112.

An air mover 102 is connected to the air outlet of the air mixer 104. In certain configurations, the air mover 102 and the air mixer 104 may be integrated into a single, integral housing or component. The air mover 102 is configured to move, pull, or draw air into the housing 105 of the air mixer 104 through either or both of the first and second air inlets 110, 112, depending on the position of the door 114 relative to the air inlets 110, 112. The air mover 102 comprises an outlet 120 through which the air exits the air mover 102. The outlet 120 may be directed into the vehicle cabin 12 and/or towards an occupant of the vehicle cabin 12 and/or the vehicle seat 14 (FIG. 1). The outlet 120 may be connected to one or more air distributors 108 for blowing. distributing, and/or diffusing air into the cabin 12 and/or towards an occupant in the seat 14.

The door 114 is connected to the actuator 118. The actuator 118 is configured or operable to move or rotate the door 114 into or between the door positions 122, 124, 126 illustrated in FIGS. 13A-13C.

The air mover 102 and/or air mixer 104 comprises a circuit board 113 located within a housing 115 and a plug 117. The circuit board 113 may also be referred to as a control unit or module or computer that is adapted or operable to control the air mover 102, the air mixer 104, the actuator 118, a position of the door 114, or a combination thereof. The plug 117 may be connected to a vehicle control unit and the circuit board 113. The plug 117 may be operable to receive power signals for operating the air mover 102 and/or air mixer 104. The plug 117 may be operable to send and/or receive communication signals from the vehicle and/or vehicle control unit. The air mover 102 and/or mixer 104 may be controlled via the circuit aboard 113. The circuit board 113 may include a processor. memory, look up table, and/or operable to run one or more programs in response to one or more communication signals received from the vehicle control unit via the plug 117. In other words, the circuit board 113 may be operable to move the door 114 into one or more of the positions described herein relative to the inlets 110, 112. The circuit board 113 may be operable to turn ON and turn OFF the air mover 102 and/or control an operating speed of the air mover 102. The plug 117 and the housing 115 containing the circuit board 113 may be integrated into the housing of the air mover and/or air mixer. This may advantageously reduce packaging space and/or reduce the number of connectors or cables required to connect to circuit boards, computers, and/or processors that are not integrated into the air mover and/or air mixer. The circuit board 115 may be integrated into the actuator 118 or they may be separate parts connected via one or more wires and/or operable to communicate wirelessly. The circuit board 115 or computer may be integrated into the housing of the air mover and/or air mixer, for controlling a position of the door, a speed of the air mover, or both.

FIGS. 13A, 13B, 13C illustrate the door 114 in various door positions 122, 124, and 126, respectively. The door 114 is moved into the various positions 122, 124, 126 by moving or rotating the door 114 with the actuator 118. The door 114 may be rotated about an axis into the positions 122, 124, 126. The axis may be generally perpendicular to an axis or flow path that the air enters and/or exits the air mixer 104. The axis may be generally parallel to the axis that the air flow exits the air mover 102 through outlet 120.

FIG. 13A illustrates the door 114 of the air mixer in the first position 122. In the first position 122, the door 114 blocks or obstructs the second air inlet 112. In the first position 122, the door 114 does not block or obstruct the first air inlet 110. Accordingly, by way of the air mover 102 being connected to the air outlet 116 of the air mixer, when the door 114 is in the first position 122, only conditioned air A1 from the conditioned air source 106 (FIG. 4) is drawn or pulled into the air mixer 104 via the first air inlet 110. The ambient air A2 from the ambient air source 107 (i.e., cabin FIG. 1) is blocked from being pulled or drawn into the air mixer 104 because the door 114 blocks or obstructs the second air inlet 112. The conditioned air A1 flows through the air mixer 114 and then exits the air mixer 114 via the air outlet 116. The conditioned output air OA1 is then pulled or drawn through the air mover 102 before being directed not the cabin and/or towards the occupant or into the air distributor 108 (FIGS. 2, 3) for distribution into the cabin and/or towards the occupant or inside the vehicle 10.

FIG. 13B illustrates the air mixer 104 with the door 114 in the second position 124, In the second position 124, the door 114 blocks or obstructs the first air inlet 110. In the second position 124, the door 114 does not block or obstruct the second air inlet 112. Accordingly, by way of the air mover 102 being connected to the air outlet 116, when the door 114 is in the second position 124, only ambient air A2 from the cabin or ambient air source 107 (FIG. 1) is drawn or pulled into the air mixer 104 via the second air inlet 112. The conditioned air A1 is not pulled or drawn into the air mixer 104 because the door 114 blocks or obstructs the first air inlet 110. The ambient air A2 flows through the air mixer 114 and then exits the air mixer 114 via the air outlet 116. The ambient output air OA2 flows is then pulled or drawn through the air mover 102 before being directed into the cabin and/or towards the occupant or into the air distributor 108 (FIGS. 2, 3) for distribution towards the occupant or inside the vehicle 10.

FIG. 13C illustrates the air mixer 104 with the door 114 in the third position 126. In the third position 126, the door 114 only partially blocks or obstructs the first air inlet 110 and only partially blocks or obstructs the second air inlet 112. In other words, in the third position 126, the door 114 does not completely block or obstruct the first air inlet 110 and does not completely block or obstruct the second air inlet 112. Accordingly, by way of the air mover 102 being connected to the air outlet 116, when the door 114 is in the third position 126, some conditioned air A1 from the conditioned air source 106 is drawn into the air mixer 104 through the first air inlet 110 and some ambient air A2 from the cabin or ambient air source 107 is drawn into the air mixer 104 through the second air inlet 112. A combined conditioned air and ambient output air OA3 is then pulled or drawn through the air mover 102 before being directed into the cabin and/or towards the occupant or into the air distributor 108 (FIGS. 2, 3) for distribution towards the occupant or inside the vehicle 10.

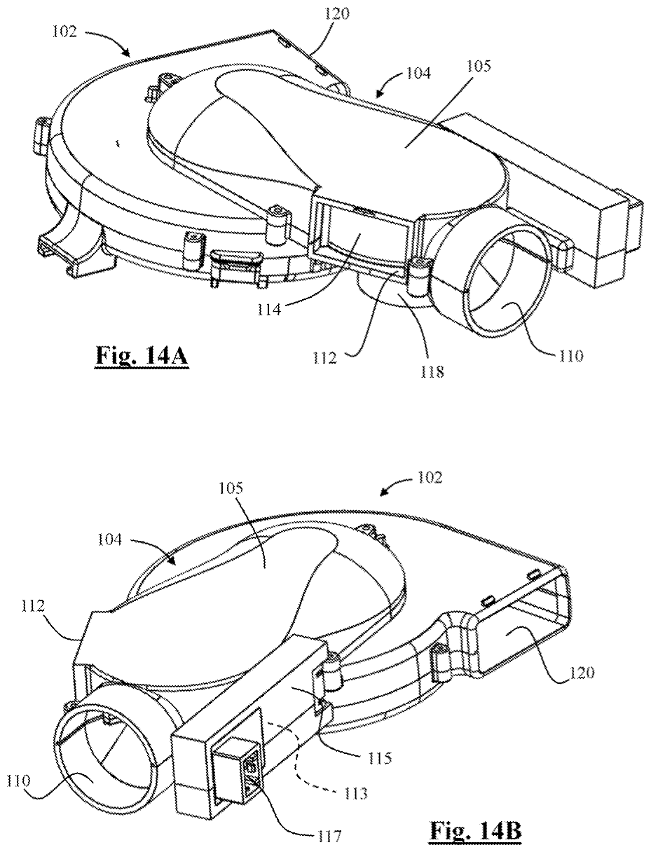

Referring to FIGS. 14A and 14B an air mixer 104 is shown comprising a housing 105 that has a first air inlet 110, a second air inlet 112, a door 114, and an air outlet 116. The first air inlet 110 is connected to or in fluid communication with the conditioned air source 106, which may be a source of warm air, a source of cold air, or both. The second air inlet 112 is located downstream of the first air inlet 110 and is connected to, in fluid communication with, or opens to a cabin or ambient air source 107 located inside the cabin 12 of the vehicle 10 (See FIG. 1). The cabin 12 or ambient air source 107 contains air inside of the vehicle 10 or cabin 12, which may also be referred to as ambient air. An actuator 118 is connected to the door 114. The actuator 118 is configured or operable to move the door 114 between a plurality of positions relative to the first and second air inlets 110, 112.

An air mover 102 is connected to the air outlet 116 of the air mixer 104. In certain configurations, the air mover 102 and the air mixer 104 may be integrated into a single, integral housing or component. The air mover 102 is configured to move, pull, or draw air into the housing 105 of the air mixer 104 through either or both of the first and second air inlets 110, 112, depending on the position of the door 114 relative to the air inlets 110, 112. The air mover 102 comprises an outlet 120 through which the air exits the air mover 102. The outlet 120 may be directed into the vehicle cabin 12 and/or towards an occupant of the vehicle cabin 12 and/or the vehicle seat 14 (FIG. 1). The outlet 120 may be connected to one or more air distributors 108 for blowing, distributing, and/or diffusing air into the cabin 12 and/or towards an occupant in the seat 14.

The air mover 102 and/or air mixer 104 comprises a circuit board 113 located within a housing 115 and a plug 117.

The actuator 118 is configured or operable to move the door 114 into or between a variety of door positions, like the ones illustrated and described above.

The actuator 118 may be located within a footprint of the air mixer 104 and/or air mover 102. Advantageously, this may reduce packaging space required for the system. Advantageously, this may reduce the amount of links or mechanisms (i.e., arms, cams) between the door and the actuator 118, which may reduce cost, weight, and complexity. This may also reduce the size of the actuator 118 in that a smaller actuator may be used.

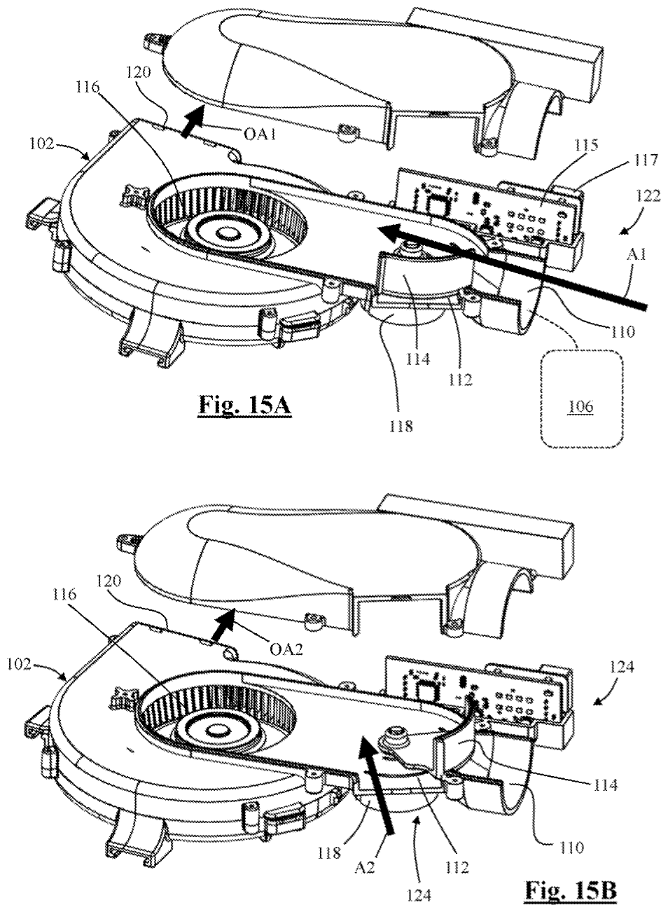

Referring now to FIG. 15A, the door 114 is illustrated in the first position 122, where the door 114 blocks or obstructs the second air inlet 112 but does not block or obstruct the first air inlet 110. Accordingly, by way of the air mover 102 being connected to the air outlet 116 of the air mixer, only conditioned air A1 from a conditioned air source 106 (See previous figures) is drawn or pulled into the air mixer 104 via the first air inlet 110. Other air, such as ambient air from the ambient air source 107 (i.e., cabin air; FIG. 1) is blocked from being pulled or drawn into the air mixer 104 because the door 114 blocks or obstructs the second air inlet 112. The conditioned air A1 flows through the air mixer 114 and then exits the air mixer 114 via the air outlet 116. The conditioned air A1 is then pulled or drawn through the air mover 102 before being expelled from the outlet 120 as conditioned output air OA1 and directed towards the occupant or into the air distributor 108 (FIGS. 2, 3) for distribution into the cabin and/or towards the occupant or inside the vehicle 10.

Referring now to FIG. 15B, the door 114 may be moved or rotated by the actuator 118 towards the other inlet 110 and into the second position 124. The axis may be generally perpendicular to an axis or flow path that the air enters and/or exits the air mixer. The axis may be generally perpendicular to an axis or flow path that the air exits the air mover 102. In the second position 124, the door 114 blocks or obstructs the first air inlet 110. In the second position 124, the door 114 does not block or obstruct the second air inlet 112. Accordingly, by way of the air mover 102 being connected to the air outlet 116, when the door 114 is in the second position 124, only ambient air A2 from the cabin or ambient air source 107 (FIG. 1) is drawn or pulled into the air mixer 104 via the second air inlet 112. The conditioned air A1 is not pulled or drawn into the air mixer 104 because the door 114 blocks or obstructs the first air inlet 110. The ambient air A2 flows through the air mixer 114 and then exits the air mixer 114 via the air outlet 116. The ambient output air OA2 flows is then pulled or drawn through the air mover 102 before being directed into the cabin and/or towards the occupant or into the air distributor 108 (FIGS. 2, 3) for distribution towards the occupant or inside the vehicle 10.

The door 114 can also be moved into a third position such that the door 114 only partially blocks or obstructs the first air inlet 110 and only partially blocks or obstructs the second air inlet 112. In other words, in the third position 126, the door 114 does not completely block or obstruct the first air inlet 110 and does not completely block or obstruct the second air inlet 112. The remarks included above in any of the preceding figures or corresponding paragraphs in this application apply and will not be recited again in the interest of brevity.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly. the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second. third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications are incorporated by reference for all purposes. Other combinations are also possible as will be gleaned from the following claims, which are also hereby incorporated by reference into this written description.

1. An air conditioning system for a vehicle seat, the air conditioning system comprising:
an air mover; and
an air mixer arranged upstream of the air mover, the air mixer comprising:
i) first air inlet configured for connection to a source of conditioned air;
ii) a second air inlet configured for connection to a source of ambient air; and
iii) a door having a convex wall;
wherein the door is configured to rotate relative to the first air inlet and the second air inlet, and the convex wall is configured to block the first air inlet and/or the second air inlet to adjust an amount of air provided to the air mover from the source of conditioned air and the source of ambient air.

2-15. (canceled)

16. The air conditioning system according to claim 1, wherein the air mover comprises an inlet, and a longitudinal axis of the first air inlet is aligned with the inlet of the air mover.

17. The air conditioning system according to claim 16, wherein the first air inlet extends along a longitudinal axis, and the door is configured to rotate about an axis that intersects the longitudinal axis.

18. The air conditioning system according to claim 17, wherein convex wall has an arc measure of 90 degrees.

19. The air conditioning system according to claim 18, wherein the first air inlet is generally perpendicular to the second air inlet.

20. The air conditioning system according to claim 18, wherein the air mixer comprises an actuator that rotates the door relative to the first air inlet and the second air inlet, the actuator is located within a footprint of the air mixer.

21. The air conditioning system according to claim 20, wherein the door of the air mixer is located at the inlet the air mover.

22. The air conditioning system according to claim 21, wherein the air conditioning system comprises a housing, and both of the air mover and the air mixer are arranged in the housing.

23. The air conditioning system according to claim 22, wherein the housing is configured for attachment to a back or bottom of the vehicle seat.

24. The air conditioning system according to claim 23, wherein the air conditioning system comprises an integrated circuit board for controlling a position of the door, a speed of the air mover, or both.

25. The air conditioning system according to claim 24, wherein the first air inlet and the second air inlet have different shapes.

26. The air conditioning system according to claim 25, wherein the first air inlet has a circular inlet, and the second air inlet has a rectangular inlet.

27. The air conditioning system according to claim 24, wherein the first air inlet and the second air inlet have the same shape.

28. An air conditioning system for a vehicle seat, the air conditioning system comprising:
a housing configured for attachment to a back or bottom of the vehicle seat;
an air mover located in the housing; and
an air mixer located in the housing and arranged upstream of the air mover, the air mixer comprising:
i) a first air inlet configured for connection to a source of conditioned air;
ii) a second air inlet configured for connection to a source of ambient air; and
iii) a door having a convex wall;
an integrated circuit board for controlling a position of the door, a speed of the air mover, or both; and
an actuator that rotates the door relative to the first air inlet and the second air inlet;
wherein the door is arranged proximal an inlet of the air mover;
wherein the first air inlet extends along a longitudinal axis, and the door is configured to rotate about an axis that intersects the longitudinal axis; and
wherein the convex wall is configured to block the first air inlet and/or the second air inlet to adjust an amount of air provided to the air mover from the source of conditioned air and the source of ambient air.

29. The air conditioning system according to claim 28, wherein the convex wall has an arc measure of 90 degrees, and the first air inlet is perpendicular to the second air inlet.
